(19) United States
(12) Patent Application Publication
(10) Pub. No.: US 2010/0208294 A1
(43) Pub. Date: Aug. 19, 2010

(54) IMAGE FORMING APPARATUS, CONTROL METHOD, AND PROGRAM

(75) Inventor: Satoshi Nishikawa, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/699,375

(22) Filed: Feb. 3, 2010

(30) Foreign Application Priority Data
Feb. 18, 2009 (JP) 2009-035816

(51) Int. Cl. G06F 3/12

(52) U.S. Cl. 358/1.15

(57) ABSTRACT

An application is determined based on an application list and output settings transmitted from a delivery server. Application information is transmitted to a user by a job completion notification, and displayed on a PC. The user can know an appropriate application which reduces his print work.

### BACKGROUND OF THE INVENTION

1. Field of the Invention

The present invention relates to an image forming apparatus, control method, and program capable of installing an application. More particularly, the present invention relates to a function of presenting an application optimum for print settings made by a user.

2. Description of the Related Art

There has conventionally been proposed a monitoring system which remotely monitors the operating status of a peripheral device such as an image forming apparatus. In this monitoring system environment, firmware of an image forming apparatus is updated as follows.

According to a conventional technique, firmware is stored in a rewritable storage device such as a flash memory. The firmware stored in the storage device is updated by transmitting firmware via the Internet using a means such as e-mail. There is also proposed a system which delivers an application in the monitoring system environment where the operating status of a peripheral device such as an image forming apparatus is monitored remotely. Japanese Patent Laid-Open No. 2002-157100 discloses a technique of displaying a message which recommends the use of an output service so that the user can easily utilize a print service with almost the same labor as that of printing with a printer in hand.

Japanese Patent Laid-Open No. 2007-42062 discloses a technique of determining a recommended application by a local host based on the type of medium or the like set in print settings by a user, and displaying it by the local host.

However, even in the foregoing application delivery system, it is difficult for the user to know an appropriate application helpful to his print work.

The present invention has been made to overcome at least some of the conventional drawbacks. More specifically, the present invention provides an image forming apparatus, control method thereof, and program capable of notifying a user of a recommended application program.

### SUMMARY OF THE INVENTION

The present invention provides an image forming apparatus which processes and outputs a print job, comprising: an acquisition unit which acquires an output condition set for the print job; a determination unit which determines, based on the condition acquired by the acquisition unit, a recommended application, installation of which is recommended to a user; and a notification unit which notifies information representing the recommended application determined by the determination unit as a job completion notification of the print job.

According to one aspect of the present invention, the user can know a proper application which reduces his print work. This can increase the efficiency of user's print work and reduce the workload.

For example, the present invention can provide a mechanism of notifying a recommended application by using a job completion notification with a very small number of steps without any cumbersome operation.

Another aspect of the present invention can provide a flexible notification method to the user so that a notification unit displays a local UI job on a local UI, or transmits and displays application information by a job completion notification to an authenticated user.

Further features of the present invention will become apparent from the following description of exemplary embodiments (with reference to the attached drawings).

### BRIEF DESCRIPTION OF THE DRAWINGS

FIG. 1 is a view exemplifying an overall system configuration in an embodiment;

FIG. 2 is a block diagram of the hardware configuration of a host in the embodiment;

FIG. 3 is a block diagram of the hardware configuration of a monitoring apparatus in the embodiment;

FIG. 4 is a block diagram exemplifying another hardware configuration of the monitoring apparatus in the embodiment;

FIG. 5 is a block diagram exemplifying the hardware configuration of an image forming apparatus in the embodiment;

FIG. 6 is a block diagram exemplifying a software configuration associated with an image forming apparatus monitoring system in a central monitoring apparatus in the embodiment;

FIG. 7 is a block diagram exemplifying a software configuration associated with the image forming apparatus monitoring system in a monitoring apparatus in the embodiment;

FIG. 8 is a block diagram exemplifying a software configuration associated with the image forming apparatus monitoring system in an image forming apparatus in the embodiment;

FIG. 9 is a view exemplifying the structure of a memory map applicable to the central monitoring apparatus, monitoring apparatus, or image forming apparatus in the embodiment;

FIG. 10 is a view showing the schematic sequence of processing in the embodiment;

FIG. 11 is a flowchart of an image forming apparatus in the first embodiment;

FIG. 12 is a flowchart of an image forming apparatus in the second embodiment;

FIG. 13 is a conceptual view of the software configuration of the image forming apparatus in the embodiment;

FIG. 14 is a table exemplifying the structure of an application list in the embodiment;

FIG. 15 is a view of a display example on the UI of a PC in the embodiment; and

FIG. 16 is a view of a display example on the UI of the PC in the embodiment.

### DESCRIPTION OF THE EMBODIMENTS

### First Embodiment

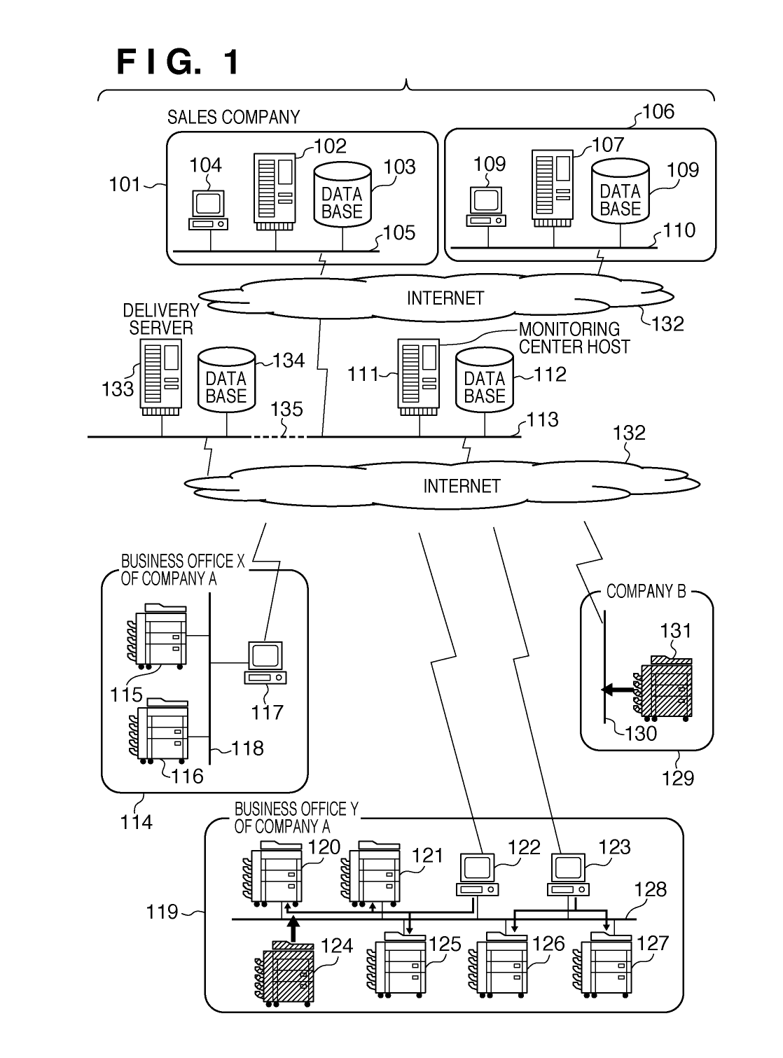

The first embodiment of the present invention will now be described with reference to the accompanying drawings. FIG. 1 is a view showing an overall management system in the first embodiment. In FIG. 1, the management system is connected to systems in a plurality of sales companies such as systems 101 and 106. The respective systems include databases 103 and 108 for accumulating sales information on the sales area and customer and information on the management system.

The systems 101 and 106 in sales companies also include PCs 104 and 109 which control registration, collection, and the like of data in the databases 103 and 108. For example, the user browses data by accessing a Web site provided by a monitoring center host 111 of the PCs 104 and 109. Hosts 102 and 107 include operation units and display units, and can also function as the PCs 104 and 109. The host 102, database 103, and PC 104 are connected to each other via a LAN 105. The host 107, database 108, and PC 109 are connected to each other via a LAN 110. In FIG. 1, each system in the sales company is formed from a plurality of apparatuses. However, it suffices to achieve functions to be described later, and the arrangement is not limited to the above-mentioned one. For example, the databases 103 and 108 may physically reside in the hosts 102 and 107. The databases 103 and 108 may also be installed in other places via Internet 132 as long as the hosts 102 and 107 can access them. That is, each system may be formed from one or a plurality of apparatuses.

The monitoring center host 111 is interposed between a sales company and a customer. A database 112 serves as a history storage unit for accumulating, for example, monitoring information, the counter of an image forming apparatus that is collected from a customer, fault history information, and a fault pattern table. The monitoring center host 111 and database 112 are connected to each other via a LAN 113, which is connectable to the Internet 132. The database 112 may physically reside in the monitoring center host 111. The database 112 may also be installed in another place via the Internet 132 as long as the monitoring center host 111 can access it. The monitoring center host 111 has a function of collecting information of a monitored image forming apparatus, and information (including fault information) representing an operating status from monitoring apparatuses 117, 122, and 123 and an image forming apparatus 131 (which will be described later), accumulating and processing these pieces of information, and externally outputting a warning and the like. For example, the monitoring center host 111 has a function of delivering pieces of information to the hosts 102 and 107 in the sales companies. The operating status is represented by, e.g., status information including the absence of toner, opening of the door, exchange of the drum, the absence of the cartridge, a cooling fan abnormality, a board abnormality, contamination of the document table glass, the absence of staples, or shortage of the light quantity of the paper feed sensor. The status information also includes overflow of the font memory, a rendering error, a fixing unit abnormality, a counter abnormality, a double-sided unit abnormality, and a paper jam. The counter information includes a charge counter for charging a sales company, a department counter totaled for each customer's department, a size counter totaled for each paper size, and a component counter representing the degree of consumption of a component in an image forming apparatus. The charge counter indicates the number of sheets printed by an image forming apparatus. The department counter indicates the number of printed sheets for each department set by a customer. The component counter indicates the number of rotations for a component such as a drum, and the time (sec) for a component such as a scanner lamp. Information representing these kinds of operating information is operating information.

The hosts 102 and 107 in the sales companies can independently register, in the monitoring center host 111, information of a monitored image forming apparatus, and monitoring settings. The monitoring center host 111 can merge and manage at once information of a monitored image forming apparatus and monitoring settings which are registered from the host of each sales company. The monitoring center host 111 can also make monitoring settings for the monitoring apparatuses 117, 122, and 123 and the image forming apparatus 131.

Services by the management system are provided based on a contract between a sales company and a customer. The management system monitors only an image forming apparatus the sales company decides to monitor under the contract. The monitoring center host 111 provides a Web page which allows a PC connected via the Internet to browse information accumulated in the database 112 or processed information. The Web page is provided by limiting the browsing contents for each sales company, each customer, and each user authority upon user authentication. The Web page allows to change some data.

A delivery server 133 is interposed between a sales company and a customer. A database 134 serves as a history storage unit for accumulating, for example, firmware, an application, and software license information to be applied to an image forming apparatus. The delivery server 133 and database 134 are connected to each other via a LAN 135, which is connectable to the Internet. The database 134 may physically exist in the delivery server 133. The database 134 may also be installed in another place via the Internet 132 as long as the delivery server 133 can access it. The LANs 113 and 135 may be formed from a single LAN, and the databases 134 and 112 may share data. FIG. 1 shows only one monitoring center host 111, one database 112, one delivery server 133, and one database 134. In practice, however, pluralities of monitoring center hosts and databases sometimes perform distributed processing to collect pieces of information from many image forming apparatuses and monitoring apparatuses, and distribute the load of firmware delivery.

A system configuration on the customer side will be explained. There are different customer environments. FIG. 1 shows customer systems 114, 119, and 129. In the customer system 114 (business office X of company A), the monitoring apparatus 117 monitors image forming apparatuses 115 and 116 connected to a LAN 118 connected to the Internet. The monitoring apparatus 117 communicates with the monitoring center host 111 via the Internet. In the customer system (business office Y of company A), the monitoring apparatuses 122 and 123 manage image forming apparatuses on a LAN 128. The monitoring apparatus 122 manages image forming apparatuses 120, 121, 124, and 125, and the monitoring apparatus 123 manages image forming apparatuses 126 and 127. The monitoring apparatuses 117, 122, and 123 are connected to a database (not shown). For example, the monitoring apparatus 117 accumulates pieces of information collected from the image forming apparatuses 115 and 116, saves the processing results of accumulated data, and saves settings in the database (not shown) in regard to monitoring of the image forming apparatuses. The database (not shown) may reside in the monitoring apparatus 117, or connected to the LAN 118 and independently arranged. The database (not shown) may also be installed in another place via the Internet as long as the monitoring apparatus 117 can access it. Every time the monitoring apparatus 117 receives status information (e.g., generation of a fault) of the image forming apparatuses 115 and 116 from them, it transmits the information to the monitoring center host 111.

In the customer system 129 (company B), the image forming apparatus 131 itself connected to a LAN 130 connected to the Internet 132 directly communicates with the monitoring center host 111 via the Internet. The image forming apparatus 131 actively transmits its information (e.g., counter information or generation of a fault) to the monitoring center host 111. With a PC (not shown) incorporating a Web browser, the user can use the Web browser to access the monitoring center host 111 not only from the customer environment but also directly via the Internet. Then, the user can browse a Web page provided by the monitoring center host 111.

In this arrangement, the following two points should be noted.

(1) Communication via the Internet in the above-described arrangement can use the HTTP/SOAP protocol. In the embodiment, SOAP is implemented on HTTP. SOAP stands for Simple Object Access Protocol. SOAP is a protocol based on XML (eXtended Markup Language) to call data and services of a given computer from another computer. SOAP is a very popular technique and a detailed description thereof will be omitted. In SOAP communication, SOAP messages each obtained by adding supplementary information to an XML document are exchanged. A computer which supports SOAP includes a SOAP message generator which generates a SOAP message, and a SOAP message interpreter which interprets a SOAP message. In the embodiment, status information of an image forming apparatus is transmitted by a SOAP message to the monitoring center host 111.

(2) In the above description, each image forming apparatus in company A communicates with the monitoring center host 111 via the monitoring apparatus. However, by changing settings, each image forming apparatus in company A can directly communicate with the monitoring center host without the mediacy of the monitoring apparatus, similar to the image forming apparatus 131 installed in company B.

<Hardware Configuration>

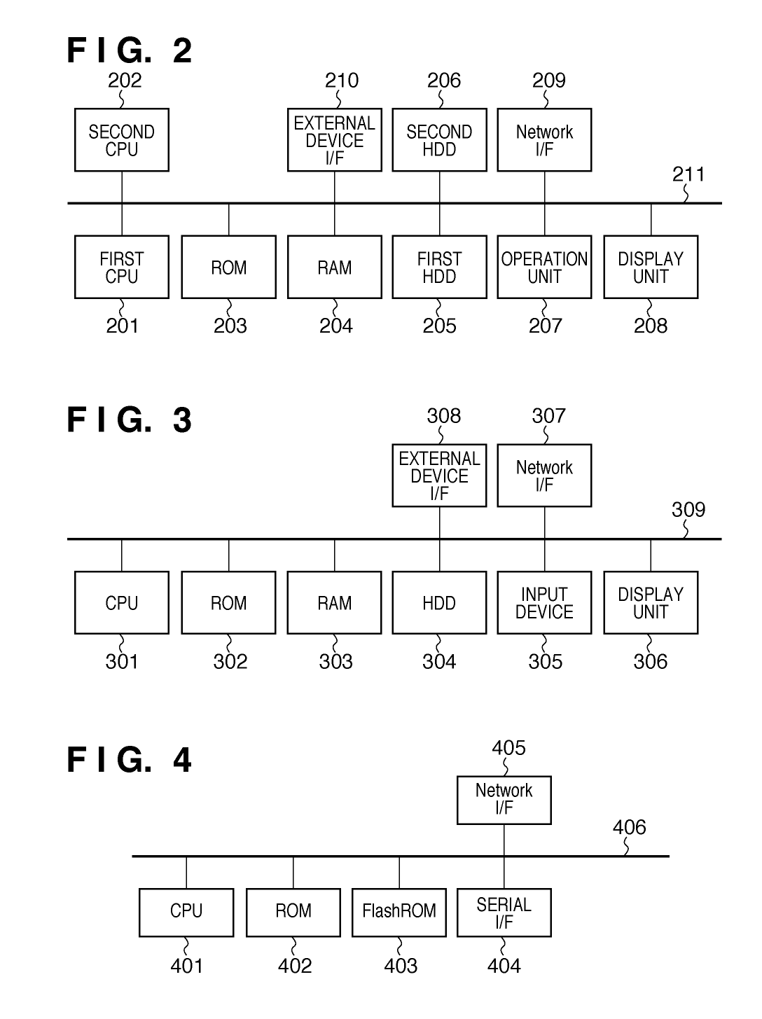

FIG. 2 is a block diagram showing the hardware configuration of the monitoring center host 111. The delivery server 133 and hosts 102 and 107 also have the same hardware configuration as that of the monitoring center host 111. In FIG. 2, a first CPU 201 and second CPU 202 control processes in the monitoring center host 111. A ROM 203, which is not rewritable, stores programs and data associated with processes in the monitoring center host 111. A rewritable RAM 204 can electrically store temporary data associated with processes in the monitoring center host 111. A first HDD 205 and second HDD 206 store programs and data associated with processes in the monitoring center host 111, temporary data, information on a monitored image forming apparatus according to the present invention, pieces of information collected from an image forming apparatus, and the like. For example, the first HDD 205 and second HDD 206 save the component counter, charge counter, department counter, and the like. An operation unit 207 includes a keyboard and pointing device which accept instruction inputs to the monitoring center host 111. A display unit 208 displays the operating status of the monitoring center host 111, and results output from each program running on the monitoring center host 111. A network I/F 209 is connected to a LAN or the Internet via a network and externally exchanges information. An external device I/F 210 connects an external storage device and the like. These components are connected to each other via a system bus 211 and exchange data.

FIG. 3 is a block diagram showing the hardware configuration of the monitoring apparatuses 117, 122, and 123. The PCs 104 and 109 also have the same hardware configuration as that of FIG. 3. A CPU 301 controls processes in the monitoring apparatus. A ROM 302, which is not rewritable, stores programs and data associated with processes in the monitoring apparatus. A rewritable RAM 303 can electrically store temporary data associated with processes in the monitoring apparatus. In the monitoring apparatus 117, an HDD 304 stores programs and data associated with processes in the monitoring apparatus, temporary data, information on a monitored image forming apparatus, pieces of information collected from an image forming apparatus, and the like. In the PCs 104 and 109, the HDD 304 stores a Web browser and the like. An input device 305 includes a keyboard and pointing device which accept instruction inputs to the monitoring apparatus. A display unit 306 displays the operating status of the monitoring apparatus, and information output from each program running on the monitoring apparatus. A network I/F 307 is connected to a LAN and the Internet via a network and externally exchanges information. An external device I/F 308 connects an external storage device and the like. These components are connected to each other via a system bus 309 and exchange data.

FIG. 4 is a block diagram showing another hardware configuration of the monitoring apparatuses 117, 122, and 123. A CPU 401 controls processes in the monitoring apparatus. A ROM 402, which is not rewritable, stores programs and data associated with processes in the monitoring apparatus. A flash ROM 403 stores data associated with processes in the monitoring apparatus, temporary data, information on a monitored image forming apparatus, pieces of information collected from an image forming apparatus, and the like. A serial I/F 404 allows to connect a terminal using a serial cable. A network I/F 405 is connected to a LAN and the Internet via a network and externally exchanges information. These components are connected to each other via a system bus 406 and exchange data.

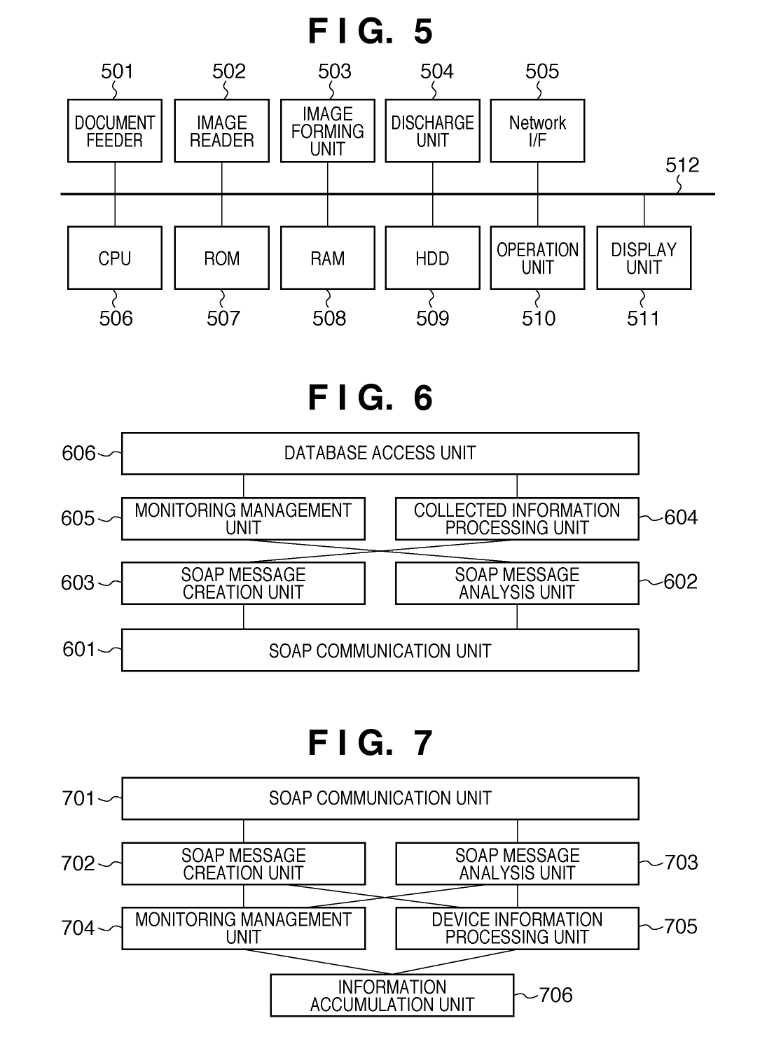

FIG. 5 is a block diagram showing the hardware configuration of the image forming apparatuses 115, 116, 120, 121, 124, 125, 126, 127, and 131. Examples of the image forming apparatus are a multifunction peripheral which integrates printer and facsimile functions, a printer (including electrophotographic and inkjet printers) which receives data from a PC or the like and prints it, a scanner, and a facsimile apparatus. FIG. 5 shows the arrangement of a multifunction peripheral as an example of the image forming apparatus. An image reader 502 reads a document on a document feeder 501. The image reader 502 and an image forming unit 503 convert a read document or data received via a network into a print image, and print out the image. A discharge unit 504 discharges a printed sheet and executes processes such as sorting and stapling. A network I/F 505 is connected to a LAN and the Internet via a network and externally exchanges information. A CPU 506 controls processes in the image forming apparatus. The CPU 506 monitors the operating status of the image forming apparatus, and when a specific event such as a fault occurs, transmits status information representing this status to a predetermined destination. The destination is, e.g., the monitoring center host 111 or monitoring apparatus. A ROM 507 serving as a nonvolatile storage unit stores programs and data associated with processes in the image forming apparatus. A rewritable RAM 508 electrically stores temporary data associated with processes in the image forming apparatus. An HDD 509 stores programs and data associated with processes in the image forming apparatus, temporary data, user data transmitted to the image forming apparatus, and the like. An operation unit 510 accepts an instruction input to the image forming apparatus. A display unit 511 displays the operating status of the image forming apparatus, and information on an operation to the operation unit 510. These components are connected to each other via a system bus 512 and exchange data. In the image forming apparatus 131 having a function of actively transmitting monitoring information from the device itself, the ROM 507 or HDD 509 holds programs and data associated with monitoring data transmission processing.

<Software Configuration>

FIG. 6 is a block diagram showing a software configuration associated with an image forming apparatus management system in the monitoring center host 111 and delivery server 133. A SOAP communication unit 601 transfers, to a SOAP message analysis unit 602, SOAP data received from the monitoring apparatus 117 or image forming apparatus 131 via the network I/F 209. Also, the SOAP communication unit 601 transmits SOAP data created by a SOAP message creation unit 603 to the monitoring apparatus 117 or image forming apparatus 131 via the network I/F 209. A collected information processing unit 604 stores information received from the monitoring apparatus 117 or image forming apparatus 131 during monitoring directly or upon processing in the database 112 or 134 via a database access unit 606. The collected information processing unit 604 implements functions associated with a remote monitoring system. For example, the collected information processing unit 604 notifies a serviceman in charge or an administrator on the customer side of total counter information, error information, and latest firmware information based on information received from the monitoring apparatus 117 or image forming apparatus 131 during monitoring, and data stored in the database 112 or database 134. A monitoring management unit 605 manages the schedule for acquiring information from the monitoring apparatus 117 or image forming apparatus 131, and controls the monitoring contents and method. If necessary, the monitoring management unit 605 transmits an instruction to the monitoring apparatus 117 or image forming apparatus 131 during monitoring via the SOAP message creation unit 603, SOAP communication unit 601, and network I/F 209.

FIG. 7 is a block diagram showing a software configuration associated with the image forming apparatus monitoring system in the monitoring apparatuses 117, 122, and 123. A SOAP communication unit 701 transfers, to a SOAP message analysis unit 703, SOAP data received from the monitoring center host 111 via the network I/F 307 or 405. Also, the SOAP communication unit 701 transmits SOAP data created by a SOAP message creation unit 702 to the monitoring center host 111 or delivery server 133 via the network I/F 307 or 405. In accordance with monitoring settings (to be described later) from the monitoring center host 111, a monitoring management unit 704 updates monitored image forming apparatus information held in an information accumulation unit, acquires information of the image forming apparatuses 115 and 116, and manages the schedule. According to the schedule managed by the monitoring management unit 704, a device information processing unit 705 accumulates, in an information accumulation unit 706, pieces of counter information actively collected by the monitoring apparatus from the image forming apparatuses 115 and 116, and information such as a service call, jam, or the absence of toner. Pieces of information are accumulated in accordance with the states of the image forming apparatuses 115 and 116. Data accumulated in the information accumulation unit 706 is directly transferred to the SOAP message creation unit 702 via the device information processing unit 705 and transmitted to the monitoring center host 111. In some cases, the accumulated data is interpreted and processed in the device information processing unit 705, transferred to the SOAP message creation unit 702, and transmitted to the monitoring center host 111.

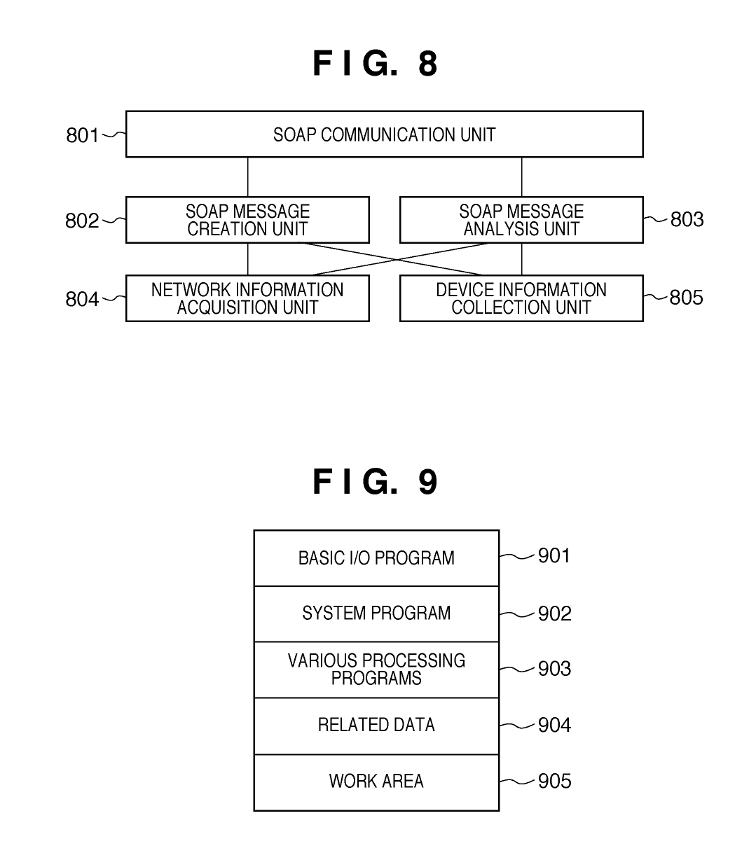

FIG. 8 is a block diagram showing a software configuration associated with the image forming apparatus monitoring system in the image forming apparatuses 115, 116, 120, 121, 124, 125, 126, 127, and 131. A SOAP communication unit 801 transfers, to a SOAP message analysis unit 803, SOAP data received from the monitoring center host 111 or delivery server 133 via the network I/F 505. Also, the SOAP communication unit 801 transmits SOAP data created by a SOAP message creation unit 802 to the monitoring center host 111 or delivery server 133 via the network I/F 505. A network information acquisition unit 804 can automatically acquire an IP address, DNS server address, and gateway address in the DHCP environment.

When network information is input from the operation unit 510 and saved in the HDD 509, the network information acquisition unit 804 acquires the information. A device information collection unit 805 acquires internally held counter information in accordance with the schedule in the multifunction peripheral or an instruction from the monitoring center host 111. The device information collection unit 805 also acquires internally generated information such as a service call, jam, or the absence of toner. The device information collection unit 805 directly transfers acquired data to the SOAP message creation unit 802 to transmit it to the monitoring center host 111. Alternatively, the device information collection unit 805 accumulates, interprets, and processes acquired data, and then transfers the resultant data to the SOAP message creation unit 802 to transmit it to the monitoring center host 111.

FIG. 9 is a view showing the structure of a memory map in the monitoring center host 111, the delivery server 133, the monitoring apparatus 117, 122, or 123, or the image forming apparatus 115, 116, 120, 121, 124, 125, 126, 127, or 131. When executing a processing program according to the present invention, the program is loaded into the RAM 204 in the monitoring center host 111, the RAM 303 or flash ROM 403 in the monitoring apparatus 117, or the RAM 508 in the image forming apparatus in accordance with the memory map of FIG. 9. The memory map is formed from a basic I/O program 901, a system program 902, various processing programs 903 including a processing program in the embodiment, an area 904 for storing related data, and a work area 905 for a program. The basic I/O program 901 controls input/output to/from the apparatus. The system program 902 provides an operating environment to each processing program.

When areas used for the programs 901 to 903 and the areas 904 and 905 run short due to a limited capacity, it is also possible to use the first HDD 205 or second HDD 206 as a partial area of the RAM 204, the HDD 304 as that of the RAM 303, and the HDD 509 as that of the RAM 508.

<Processing Sequence and Interface>

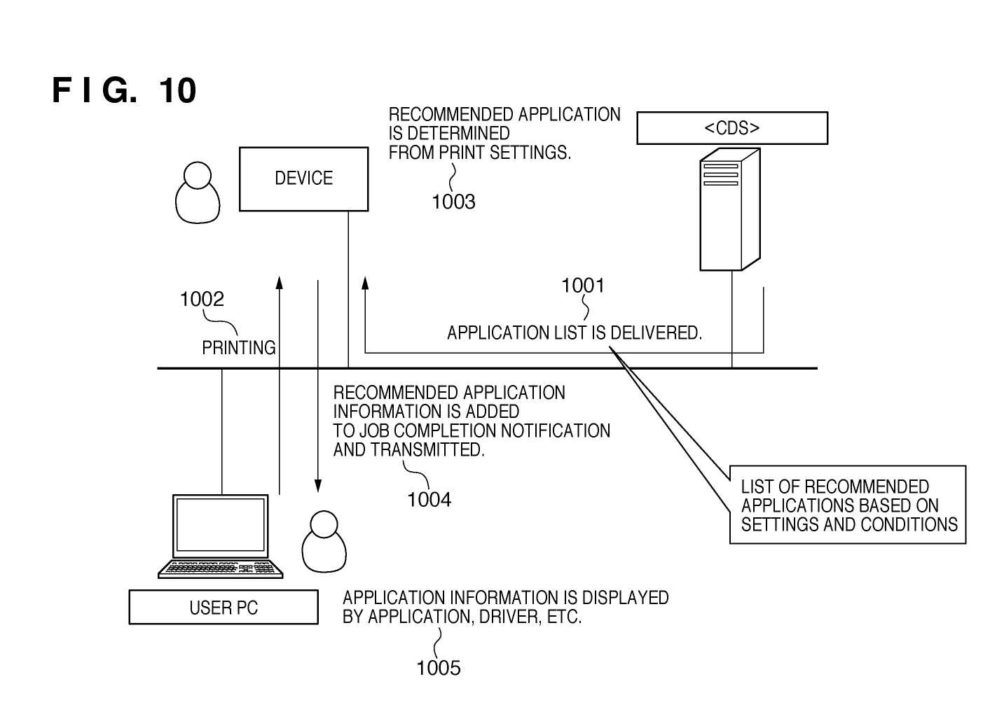

FIGS. 10 to 16 are views exemplifying the sequence, interface, and the like of an image forming apparatus firmware delivery system which is a feature of the present invention. A processing sequence in the present invention will be explained with reference to these drawings. A general sequence according to the present invention in the image forming apparatuses 124 and the like, the delivery server 133, and the user PC in FIG. 1 will be explained with reference to FIG. 10. With the foregoing hardware and software configurations, software containing an application program (to be referred to as an application) installable in an image forming apparatus is delivered.

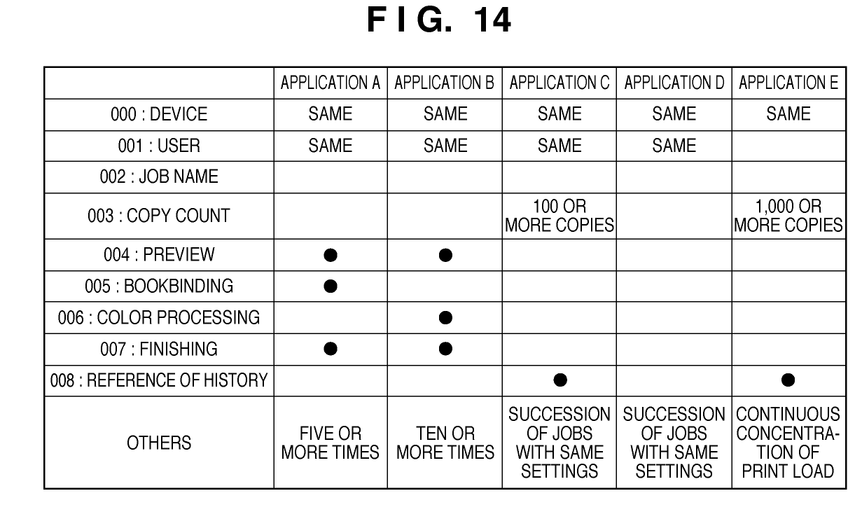

First, the delivery server 133 delivers (1001) an application list. The application list is a list of applications necessary to determine a recommended application later by the image forming apparatus 124 or the like. The list of applications will be called an application list, details of which will be described with reference to FIG. 14. The application list is delivered in a connectivity test upon installing the image forming apparatus 124 or the like, in response to a request from the image forming apparatus 124 or the like, or at a subsequent timing to update the application list itself. Alternatively, the application list may be delivered together with image forming apparatus firmware or an application. The application list delivery timing is not limited to them and is arbitrary. The image forming apparatus 124 holds a received application list and if necessary, updates it.

In contrast, the user of the image forming apparatus 124 or the like uses a network-connected PC to print (1002) based on various print settings. These print settings are made by the user and the contents are arbitrary. Then, the image forming apparatus 124 or the like determines (1003) a recommended application from the print settings made by the user and the application list received from the delivery server. The image forming apparatus 124 or the like adds (1004) the determined recommended application information to a job completion notification, and transmits it. The user PC receives the job completion notification and displays (1005) the recommended application information via the driver, application, or the like which has printed.

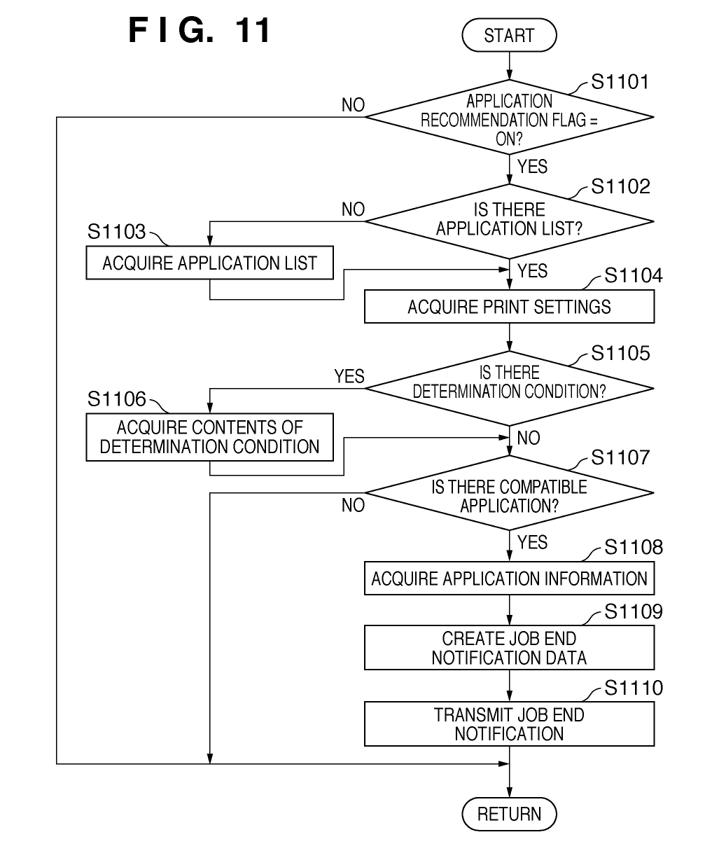

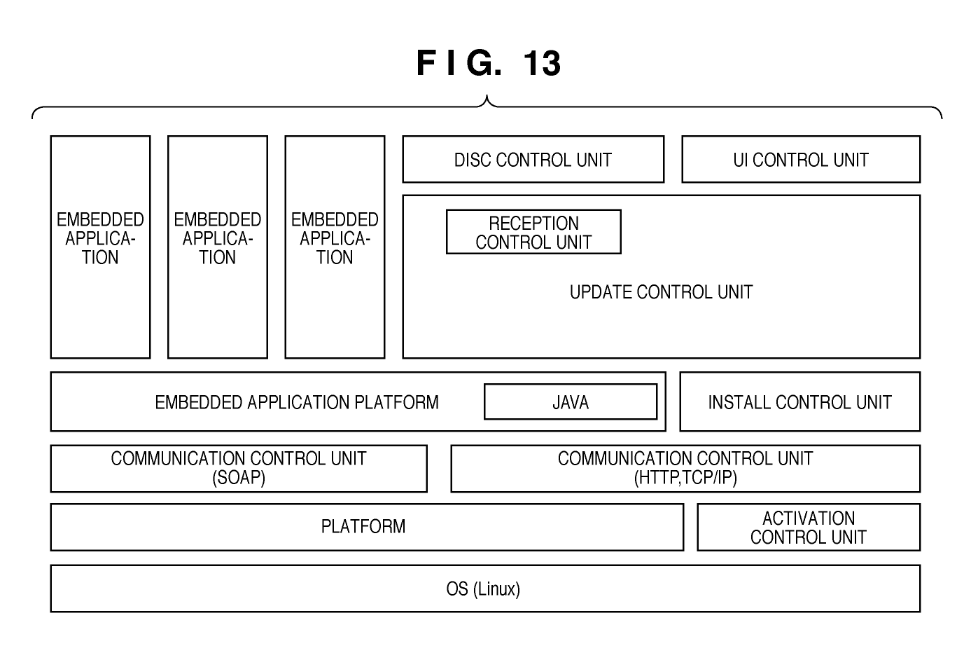

A processing sequence in the present invention will be explained with reference to FIG. 11. An update control unit 1309 in FIG. 13 performs the processing of this sequence, unless otherwise specified. The program of the processing is read out from the HDD 509 to the RAM 508 in FIG. 5 and processed by the CPU 506. The processing may start after completion of processing a print job or may be executed parallel to processing of a print job. When parallel-performing the processing, it needs to be synchronized with the print job in S1109 (to be described later).

The update control unit 1309 determines whether an application recommendation flag is ON (S1101). In this processing, the update control unit 1309 determines whether to recommend an application to the user. When an application is recommended, a setting flag regarding notification of a recommended application in the image forming apparatus 124 or the like can be set on. If the flag is ON to recommend an application, the process advances to S1102. If no application is recommended, the process ends. The update control unit 1309 determines whether there is an application list (S1102). In this processing, update control unit 1309 determines whether the above-described application list transmitted from the delivery server 133 has already been acquired. If the application list has been acquired, the process advances to S1104; if NO, to S1103. In application list acquisition processing S1103, the image forming apparatus sends an inquiry to the delivery server 133 to communicate with it and acquire an application list. After that, the process advances to S1104.

FIG. 14 exemplifies the application list. This application list is a list of recommended applications, print settings, and conditions (example of output conditions). FIG. 14 shows an example of the structure of the application list. Each column corresponds to an application, and each row corresponds to an item such as a print setting. Cells represent print settings and conditions for recommending an application. For example, application A is recommended when the preview setting, bookbinding setting, finishing setting, and the like are made five or more times with the same device by the same user. Applications B to F are similarly recommended based on this application list. The recommendation conditions are freely settable and are not limited to those shown in FIG. 14. For an application having a plurality of conditions, the conditions may be AND or OR conditions.

The update control unit 1309 performs print setting acquisition processing S1104. In this processing, the update control unit 1309 acquires setting contents made for a print job. The process then advances to S1105. In determination processing S1105, the update control unit 1309 determines whether there is a determination condition. In this processing, it is determined whether a determination condition is set separately from print settings. The determination condition corresponds to an item “others” in the application list example of FIG. 14. If there is a determination condition, the process advances to S1106; if NO, to S1107. In determination condition acquisition processing S1106, the update control unit 1309 acquires, from the application list, a determination condition corresponding to a print condition acquired in print setting acquisition processing S1104. For example, when the bookbinding setting has been acquired in print setting acquisition processing S1104, application A corresponding to the bookbinding setting is selected from the application list. The determination condition “five or more times” of application list A in the item “others” is acquired. “Five or more times” means that “a setting corresponding to application A has been made five or more times for a print job.”

Subsequently, the update control unit 1309 executes determination processing S1107 to determine whether there is a compatible application. In this processing, the update control unit 1309 determines, based on the previously acquired print settings and application determination condition, whether a compatible application exists in the application list. If there is a compatible application, the process advances to S1108; if NO, the process ends. More specifically, the bookbinding setting as a print condition and information “five times” as a determination condition have been acquired in the preceding processes. If the determination condition is satisfied based on information such as a job history representing that the device and user remain unchanged and the setting count is five, it is determined that there is a compatible application. If an application matches the print settings but does not meet the determination condition, it is determined that there is no compatible application, and the process ends. Determination of the condition sometimes requires information on the job history (e.g., log) of an image forming apparatus. This information may be one held in the image forming apparatus or one managed by the monitoring apparatus during monitoring, and the form of the information is arbitrary. In addition to the condition concerning the history, a condition concerning the status of an image forming apparatus may also be defined.

If there is a compatible application, the process advances to S1108 to execute application information acquisition processing. In this processing, the update control unit 1309 acquires information of an application determined in S1107 to be compatible, such as the name of the determined application. For example, a name “application A” in the application list shown in FIG. 14 is acquired. Thereafter, the update control unit 1309 performs job end notification data creation processing S1109. In this processing, the update control unit 1309 creates notification data on a recommended application that is to be assigned to data to be transmitted to the PC by a subsequent job end notification. The notification data is created based on the information acquired in S1108. More specifically, a character string such as “Application A is convenient for booklet printing.” is created as data to be displayed later as created data. Although the character string is displayed, the created contents are not particularly limited to it, and the notification data may be created in accordance with, e.g., the type of application. However, the notification data desirably contains a character string which specifies a recommended application, and further desirably contains a character string representing the function of the recommended application. When executing this sequence parallel to processing of a print job, the sequence needs to be synchronized with the print job in this step to perform subsequent processing. After that, the update control unit 1309 performs job completion notification transmission S1110. In this processing, the update control unit 1309 transmits a job completion notification containing the data generated in S1109. The job completion notification may be a series of job languages transmitted between a PC and a device or may be sent by mail, and the form of the job completion notification is arbitrary. As information of the job completion notification in the job language, the data generated in S1109 is assigned as a parameter and transmitted.

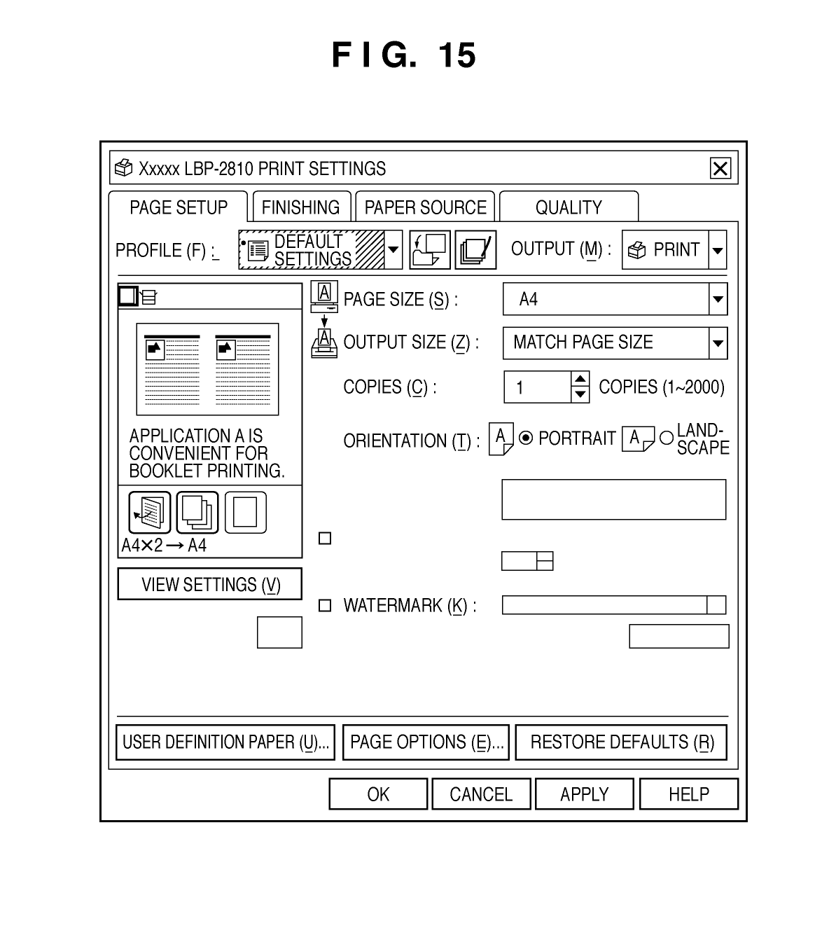

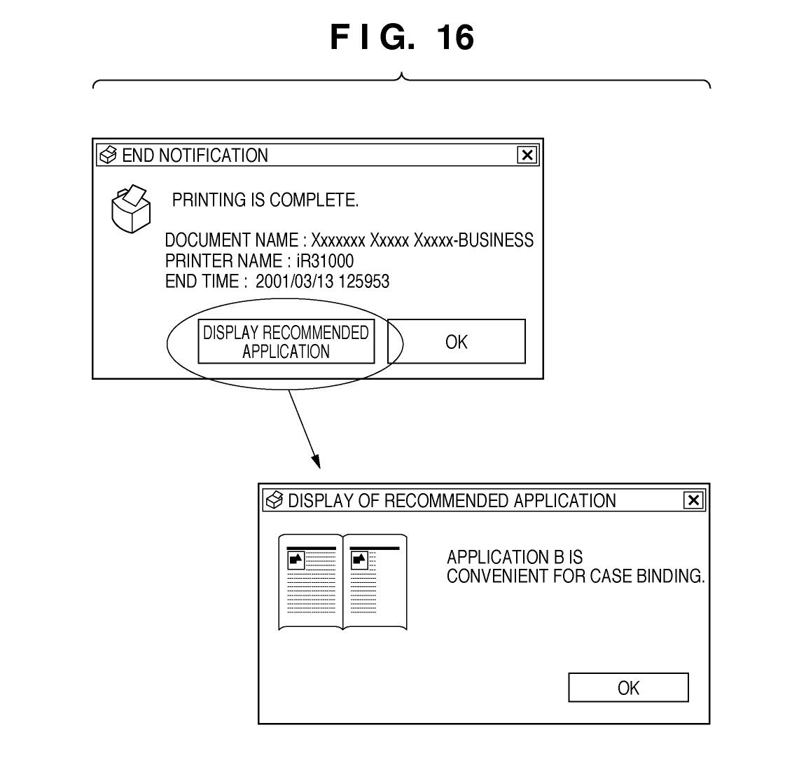

FIG. 15 exemplifies received data displayed by a driver on the PC side. In this example, a character string is displayed at the center on the left side of FIG. 15. Alternatively, the data may be displayed in, e.g., an installed print end notification, and FIG. 16 shows this display example. In this form, a button “display a recommended application” is pressed to display information on a recommended application. Although the two display forms are exemplified, the display form is not limited to them and is arbitrary as long as the user can be notified of a recommended application. It is also possible to notify one recommended application or if there are a plurality of recommended applications, a plurality of recommended applications. A recommended application can be notified regardless of whether it has already been installed in an image forming apparatus or is not installed yet. The series of operations can display a recommended application suited to print settings used by the user. The user can know a proper application which reduces his print work. This can increase the efficiency of user's print work and reduce the workload. The embodiment discloses the delivery server 133 serving as an example of a delivery apparatus which delivers a list of applications installable in the image forming apparatus 124 serving as an example of an image forming apparatus.

The embodiment discloses the image forming apparatus 124 connected to the delivery server 133. An output condition set for a print job is acquired under the control of the firmware and delivery program of the image forming apparatus. A recommended application is determined based on the output condition under the control of the firmware and delivery program of the image forming apparatus. Further, information representing a determined recommended application is notified as the job completion notification of the print job under the control of the firmware and delivery program of the image forming apparatus.

### Second Embodiment

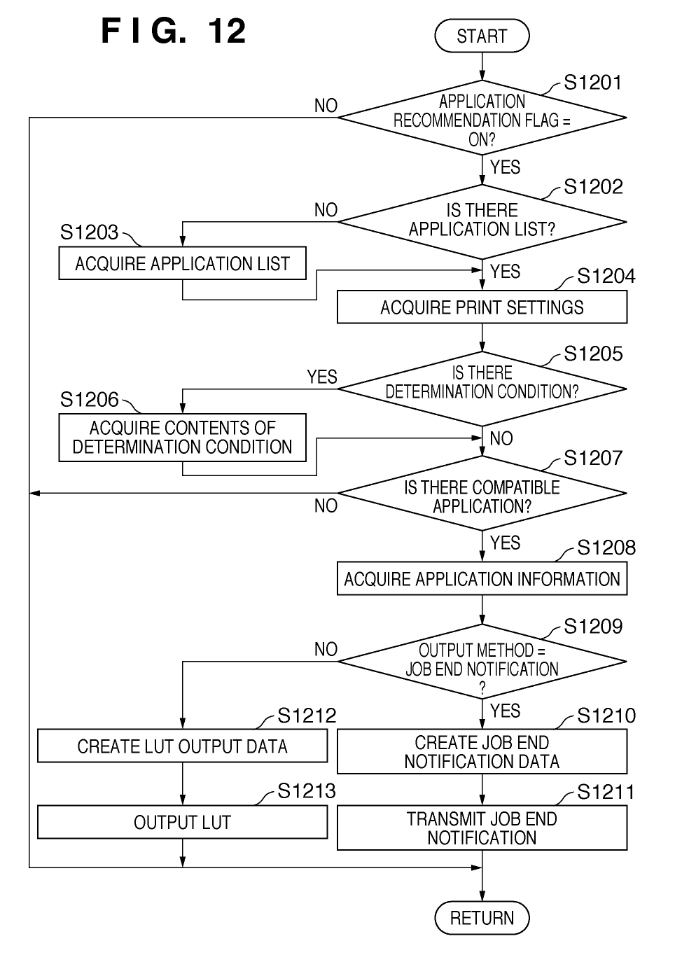

In another case, there is a choice of displaying application information on a local UI. The local UI is a display unit 511. That is, a device displays recommended application information, instead of the processes 1004 and 1005 in FIG. 10. The sequence of processing in this case will be explained with reference to FIG. 12. An update control unit 1309 in FIG. 13 performs the processing of this sequence, unless otherwise specified. The program of the processing is read out from an HDD 509 to a RAM 508 in FIG. 5 and executed by a CPU 506. The processing may start after completion of a print job or may be executed parallel to processing of a print job, similar to the first embodiment. The processes of S1201 to S1208 in this sequence are the same as those of S1101 to S1108 in FIG. 11 described in the first embodiment. Thus, only the sequence of these processes will be described, and a detailed description such as a concrete example will be omitted.

First, the update control unit 1309 determines whether an application recommendation flag is ON (S1201). In this processing, the update control unit 1309 determines whether to recommend an application to the user. When an application is recommended, a setting flag regarding notification of a recommended application in an image forming apparatus 124 or the like can be set on. If the flag is ON to recommend an application, the process advances to S1202. If no application is recommended, the process ends. The update control unit 1309 determines whether there is an application list (S1202). If the application list has been acquired, the process advances to S1204; if NO, to S1203. In application list acquisition processing S1203, the image forming apparatus communicates with a delivery server 133 to acquire an application list. After that, the process advances to S1204. The update control unit 1309 performs print setting acquisition processing S1204, and the process advances to S1205. The update control unit 1309 executes determination processing S1205 to determine whether there is a determination condition. If there is a determination condition, the process advances to S1206; if NO, to S1207. In determination condition acquisition processing S1206, the update control unit 1309 acquires, from the application list, a determination condition corresponding to a print condition acquired in S1204. Subsequently, the update control unit 1309 performs determination processing S1207 to determine whether there is a compatible application. If there is no compatible application, the process ends. If an application matches the print settings but does not meet the determination condition, it is determined that there is no compatible application, and the process ends. If there is a compatible application, the process advances to S1208 to perform application information acquisition processing. The sequence of these steps is the same as that in the first embodiment.

Then, the update control unit 1309 executes determination processing S1209 to determine whether the output method is a job end notification. In this processing, the update control unit 1309 determines whether to adopt not a job end notification described in the first embodiment but output via the local UI as the recommended application output method. Output via the local UI can be coped with by selecting a setting in advance. If a job end notification is adopted, the process advances to S1210. If output via the local UI is adopted in place of the job end notification, the process advances to S1212. When outputting a job end notification, the update control unit 1309 performs job end notification data creation processing S1210, which is the same processing as S1109 in the first embodiment. Thereafter, the process advances to S1211. The update control unit 1309 performs job completion notification transmission S1211, which is also the same processing as S1110 in the first embodiment. In this processing, the update control unit 1309 transmits a job completion notification containing the data generated in S1210.

When performing output via the local UI, the update control unit 1309 executes local UI output data creation processing S1212. In this processing, the update control unit 1309 creates data to be output in subsequent local UI output processing S1213. For example, a character string “Application A is convenient for booklet printing.” is created. Although the character string is displayed in the embodiment, the contents are not particularly limited, and the display contents and the like are arbitrary. After generating local UI output data, the process advances to S1213. In local UI output processing S1213, the character string is displayed on the local UI.

By the series of operations, a recommended application can be presented to the user. The user can know an appropriate application which reduces his print work. This can increase the efficiency of user's print work and reduce the workload. In addition, the embodiment can provide a flexible display method so that a job on a local UI is displayed on the local UI, or application information is transmitted and displayed by a job completion notification to an authenticated user.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-035816, filed Feb. 18, 2009, which is hereby incorporated by reference herein in its entirety.

What is claimed is:

1. An image forming apparatus which processes and outputs a print job, comprising:
an acquisition unit which acquires an output condition set for the print job;
a determination unit which determines, based on the condition acquired by said acquisition unit, a recommended application, installation of which is recommended to a user; and
a notification unit which notifies information representing the recommended application determined by said determination unit as a job completion notification of the print job.

2. The apparatus according to claim 1, wherein when notification data contained in the job completion notification is set to be displayed on a display unit of the image forming apparatus, said notification unit displays the notification data on the display unit of the image forming apparatus.

3. The apparatus according to claim 1, further comprising a hold unit which receives and holds a list of applications delivered from a delivery apparatus, when said hold unit does not hold the list, said hold unit inquiring the list of the delivery apparatus to acquire the list.

4. The apparatus according to claim 3, further comprising a setting unit which accepts a setting of whether to notify the recommended application based on the list.

5. The apparatus according to claim 1, wherein said determination unit determines the recommended application to be notified based on a history of the print job.

6. A method of controlling an image forming apparatus which processes and outputs a print job, the method comprising:
an acquisition step of causing an acquisition unit of the image forming apparatus to acquire an output condition set for the print job;
a determination step of causing a determination unit of the image forming apparatus to determine, based on the output condition acquired in the acquisition step, a recommended application, installation of which is recommended to a user; and
a notification step of causing a notification unit of the image forming apparatus to notify information representing the recommended application determined in the determination step as a job completion notification of the print job.

7. A computer-readable storage medium storing a program for causing a computer to function as
an acquisition unit which acquires an output condition set for a print job,
a determination unit which determines, based on the condition acquired by said acquisition unit, a recommended application, installation of which is recommended to a user, and
a notification unit which notifies information representing the recommended application determined by said determination unit as a job completion notification of the print job.
